(19) United States
(12) Patent Application Publication
(10) Pub. No.: US 2007/0041800 A1
(43) Pub. Date: Feb. 22, 2007

(54) Door lock installation kit

(76) Inventor: Jay Patrick Santos, Markham (CA)

Correspondence Address: Ralph A. Dowell of DOWELL & DOWELL P.C., 2111 Eisenhower Ave, Suite 406, Alexandria, VA, 22314, US

(21) Appl. No.: 11/205,329

(22) Filed: Aug. 17, 2005

(51) Int. Cl. B23B 47/28

(52) U.S. Cl. 408/115 R

(57) ABSTRACT

The present invention is a door lock installation kit for use as an aide to cutting holes in a door wherein a required backset from the edge of the door for the hole is chosen from at least two predetermined backsets. The kit includes a U-shaped bracket and at least one hole saw guide. The U-shaped bracket has a front portion and a first and second side portion perpendicular thereto. Each hole saw guide is removably attachable to one of the first and second side portions. Each hole saw guide has a saw hole a predetermined distance from each end thereof. Each hole saw guide is attachable in at least a first and a second position such that in the first position the backset is a first backset and in the second position the backset is a second backset.

### FIELD OF THE INVENTION

This invention relates to door lock installation kits and in particular door lock installation kit that may be used with a variety of door thicknesses and setbacks.

### BACKGROUND OF THE INVENTION

Most residential and commercial doors include a door lockset. The vast majority of these are standard door lockset with a predetermined setback from the edge of the door. Common procedure for installing a standard lockset to a door requires the drilling of a 2⅛″ hole through the face of the door and a 1″ hole on the edge of the door perpendicular and in alignment with the 2⅛″ hole. Installing standard locksets to a door requires two types of information: the thickness of the door and the backset distance of the hole on the face of the door.

There are various devices adapted to aid to drill the holes for a standard lockset on a door that accommodate the thickness and backsets. For example, US pending patent application # 2004/0240950 covers two ways: an “L-shaped” bracket and a “U-shaped” bracket in which both are mounted to the edge of the door and can be manipulated to accommodate the backsets. The “U-shaped” bracket consists of a flexible plastic that clamps onto the door edge. Another example of a lockset drilling guide is shown in US pending patent application 2004/0062618 which includes a generally L-shaped bracket with a pair of spacing tabs so that the guide may be used with doors of two different thicknesses. There are number of limitations with this and other guides. Specifically, these guides are not readily adaptable for use with different backsets.

Accordingly, it would be advantageous to provide a door lock installation kit that is easy to use and may be adapted for use with different thicknesses of doors. Further it would be advantageous to provide a door lock installation kit that may be adapted for use with different backsets.

### SUMMARY OF THE INVENTION

The present invention is a door lock installation kit for use as an aide to cutting holes in a door wherein a required backset from the edge of the door for the hole is chosen from at least two predetermined backsets. The kit includes a U-shaped bracket and at least one hole saw guide. The U-shaped bracket has a front portion and a first and second side portion perpendicular thereto. Each hole saw guide is removably attachable to one of the first and second side portions. Each hole saw guide has a saw hole a predetermined distance from each end thereof. Each hole saw guide is attachable in at least a first and a second position such that in the first position the backset is a first backset and in the second position the backset is a second backset.

In another aspect of the invention there is provided a door lock installation kit for use as an aide to cutting holes in a door wherein the door is one of two predetermined thicknesses. The kit includes a U-shaped bracket and at least one hole saw guide. The U-shaped bracket has a front portion and a first and second side portion perpendicular thereto. The side portions each have an inside surface. The at least one hole saw guide is removably attachable to one of the first and second side portions. Each hole saw guides have a surface. Each hole saw guide is attachable in a first and second door thickness position, wherein in the first door thickness position the surface of the first and second hole saw guides adjacent to inside surface of the side portions of the U-shaped bracket is in the same plane and in the second door thickness position at least a portion of the surface is spaced inwardly from the inside surface of the side portions of the U-shaped bracket.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a perspective view of the door lock installation kit of the present invention showing the template orientation for a 1¾″ thick door with a 2⅜″ backset;

FIG. 2 is a blown apart perspective view of the door lock installation kit of the present invention showing a 2⅛″ hole saw guides removed from the U-shaped bracket;

FIG. 3 is a perspective view of the door lock installation kit similar to that shown in FIG. 1 but showing the template orientation for a 1⅜″ thick door with a 2⅜″ backset;

FIG. 4 is a perspective view of the door lock installation kit similar to that shown in FIG. 2 but showing a 2⅛″ hole saw guides with a 1⅜″ thick door orientation removed from the U-shaped bracket;

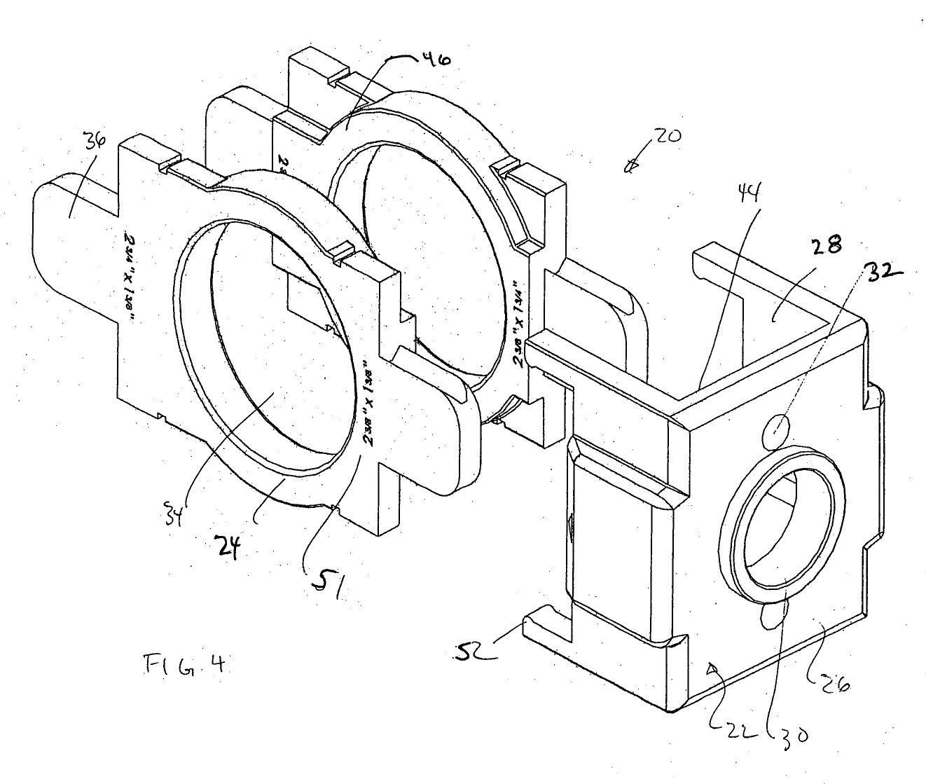

FIG. 5 is a perspective view of the door lock installation kit showing the template orientation for a 1¾″ thick door with a 2¾″ backset;

FIG. 6 is a perspective view of the door lock installation kit showing the template orientation for a 1⅜″ thick door with a 2¾″ backset;

FIG. 7 is a perspective view of the door lock installation kit showing the template being mounted to the edge of the door with two standard screws;

FIG. 8 is a perspective view of the door lock installation kit showing the template mounted on a door with two hole saws poised to cut the holes in the door;

FIG. 9 is a top view of the door lock installation kit showing the template mounted on a 1⅜″ thick door;

FIG. 10 is a top view of the door lock installation kit showing the template mounted on a 1¾″ thick door;

FIG. 11 is a side view of the door lock installation kit showing the template mounted on a door with a 2⅜″ backset;

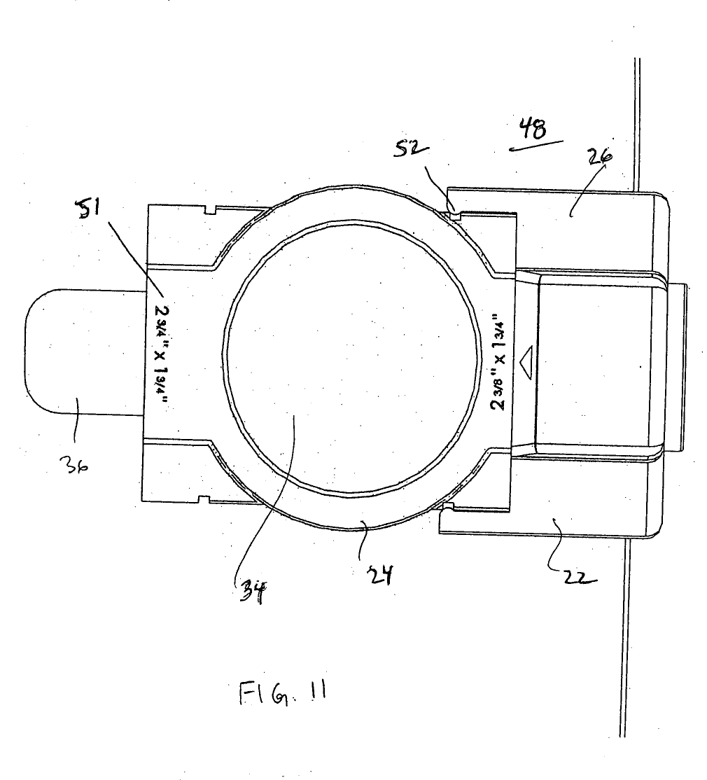

FIG. 12 is a side view of the door lock installation kit similar to that shown in FIG. 11 but showing the template mounted on a door with a 2¾″ backset;

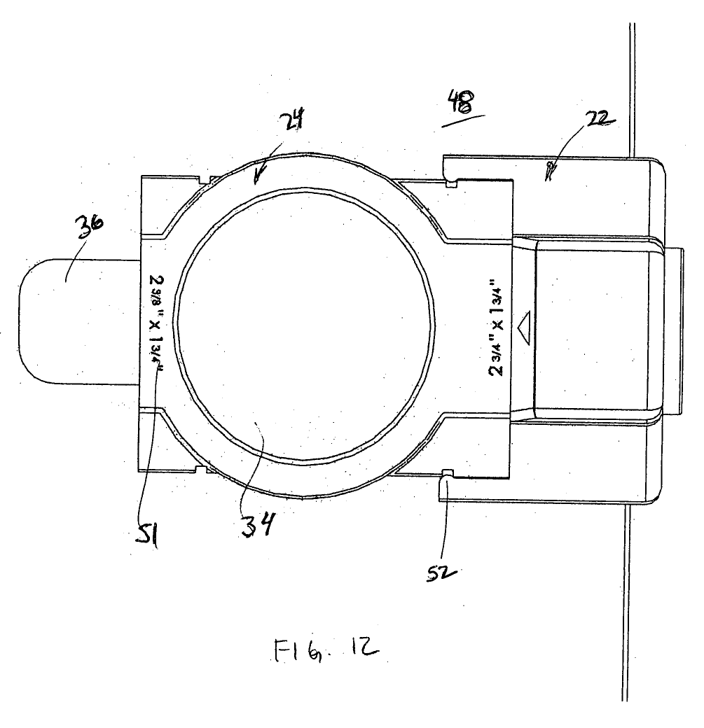

FIG. 13 is an enlarged partial side view of the door lock installation kit showing the orientation of the 2⅛″ hole guide attached to the U-shaped bracket;

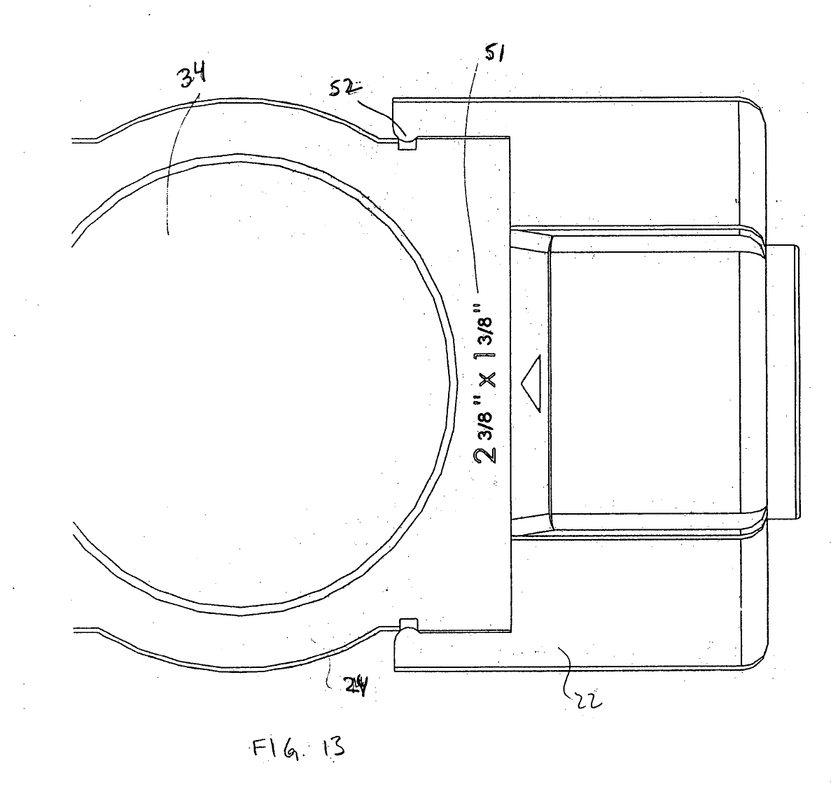

FIG. 14 is an enlarged end view of the U-shaped bracket showing the inside area of the template with the 1″ hole and screw holes;

FIG. 15 is a perspective view of an alternate embodiment of the door lock installation kit of the present invention showing the template orientation for a 1⅜″ thick door with a 2⅜″ backset;

FIG. 16 is a perspective view of the door lock installation kit of the present invention showing the kit including a mandrel, a hole saw and a latch hole saw; and

FIG. 17 is a blown apart perspective view of the door lock installation kit of FIG. 16.

### DETAILED DESCRIPTION OF THE INVENTION

The door lock installation kit of the present invention is used as an aide to correctly cutting the holes for the installation of a door lock. Generally a hole is required for the handle portion that extends through the thickness of the door and another hole that is perpendicular to the handle hole for the latch. The latch hole extends parallel to the plane of the door and intersects the handle hole. The door lock installation kit aids someone to cut the handle hole and the latch hole.

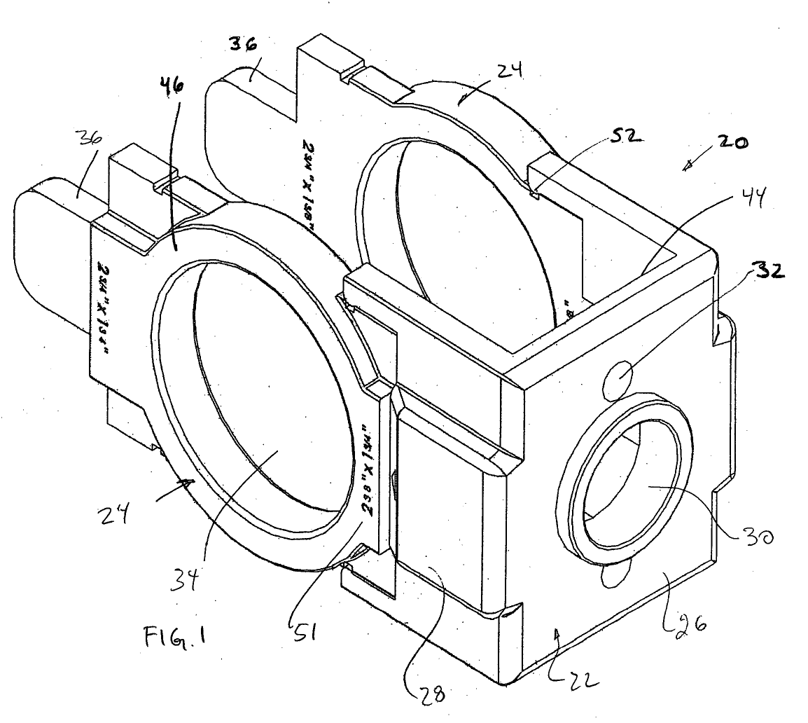

Referring to FIG. 1, the template of the door lock installation kit of the present invention is shown generally at 20. The template 20 includes a U-shaped bracket 22 and a first and second removable hole saw guides 24.

The U-shaped bracket 22 has a front portion 26 and a first and second side portion 28. The side portions 28 are generally perpendicular to the front portion 26. The front portion has a latch hole 30 generally in the centre thereof. A pair of screw holes 32 are positioned above and below the latch hole 30. The position of the screw holes 32 generally correspond to the position of the holes on a cover plate for a latch (not shown).

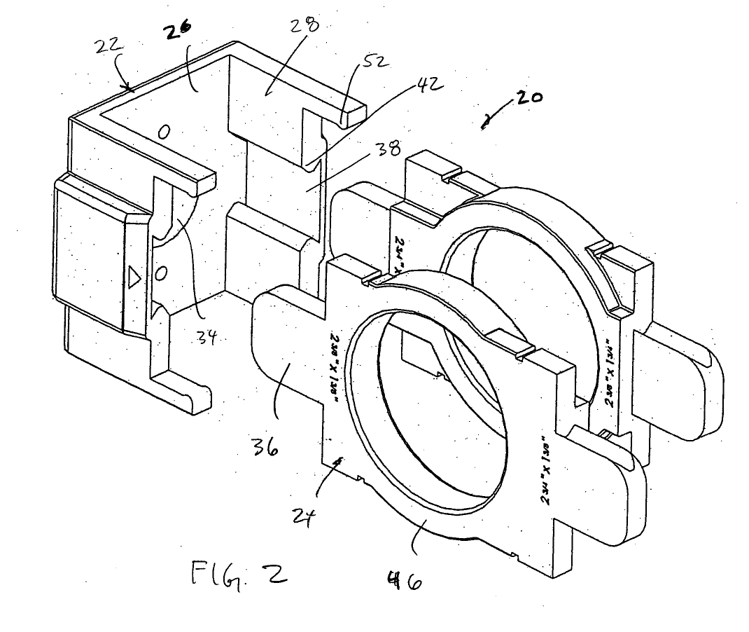

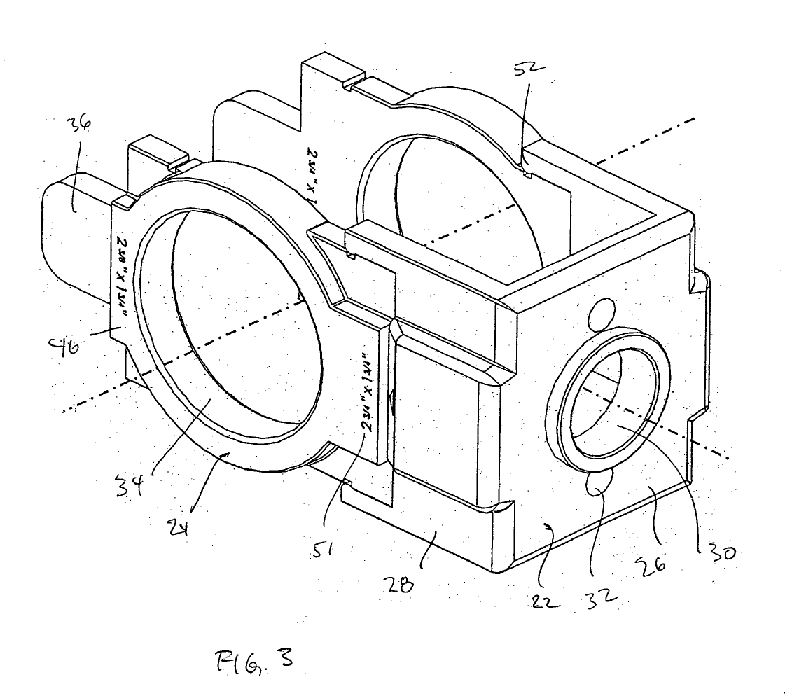

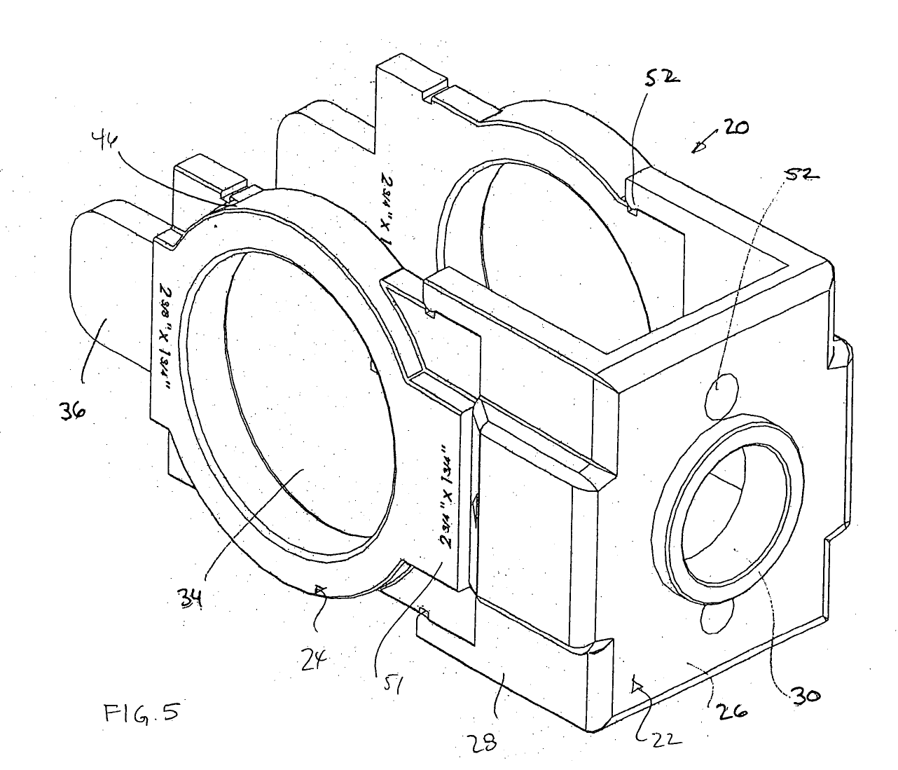

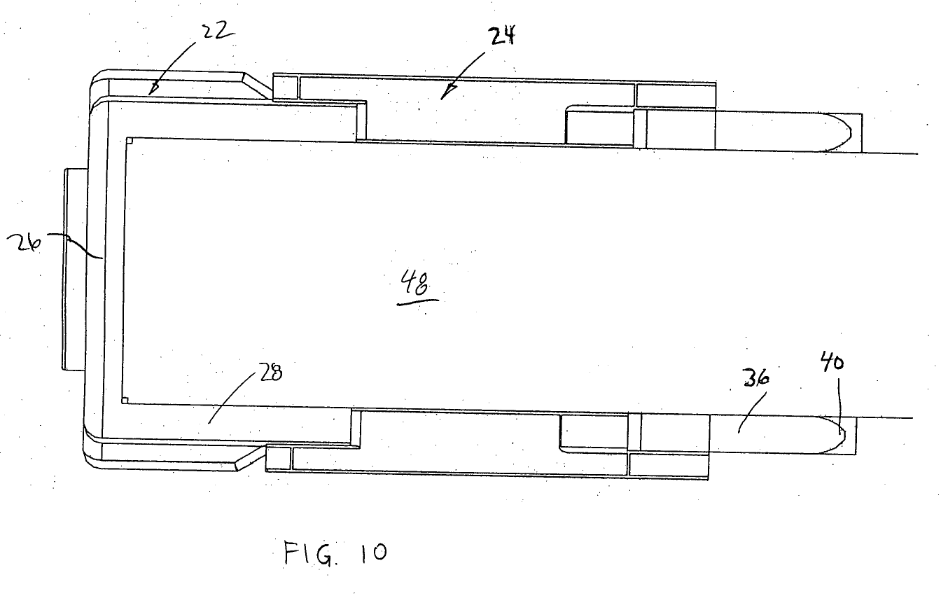

The first and second removable hole saw guides 24 each have a saw hole 34. Each guide 24 is removably attachable to the side portions 28 of the U-shaped bracket 22. The guides 24 are attachable in four possible positions. Each guide 24 has a finger 36 that extends outwardly from each end thereof and is receivable into a channel 38 (shown in FIG. 2) in the side portions 28 of U-shaped bracket 22. Each finger 36 has a generally V-shaped groove 40 formed therein on the side of the finger 36 as best seen in FIG. 2. Groove 40 corresponds to a generally V-shaped elongate ridge 42 on the side of channels 38. The guides 24 are constructed such that when positioned in U-shaped bracket 22 the backset, which is the distance from the inside edge 44 of the U-shaped bracket 22 to the saw hole 34, is a first predetermined distance when the guide 24 is in a first position and is a second predetermined distance when the guide 24 is in a second position. In the first position shown in FIG. 1, the backset is less than the backset of the second position shown in FIG. 5. In the first and second positions, the inside surface of the guide 24 is flush with or in the same plane as the inside surface of the side portion 28 as shown in FIGS. 1, 5, 7, 8 and 10. When the guides 24 are in position the saw holes 34 are in alignment and the centre points of the saw holes 34 and the latch hole 30 are in the same plane as shown in FIG. 3.

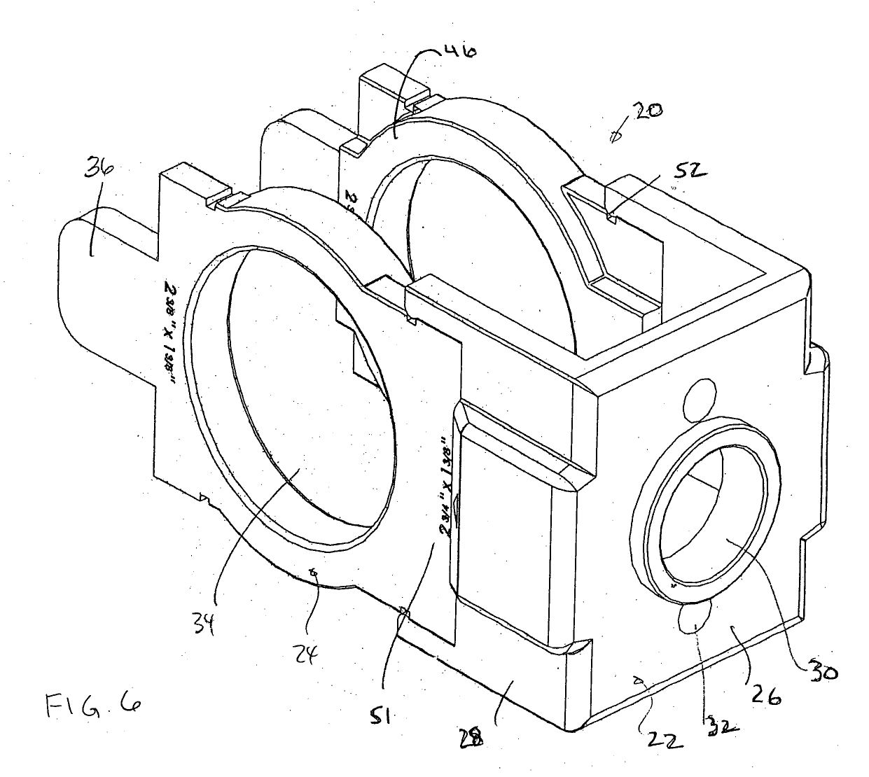

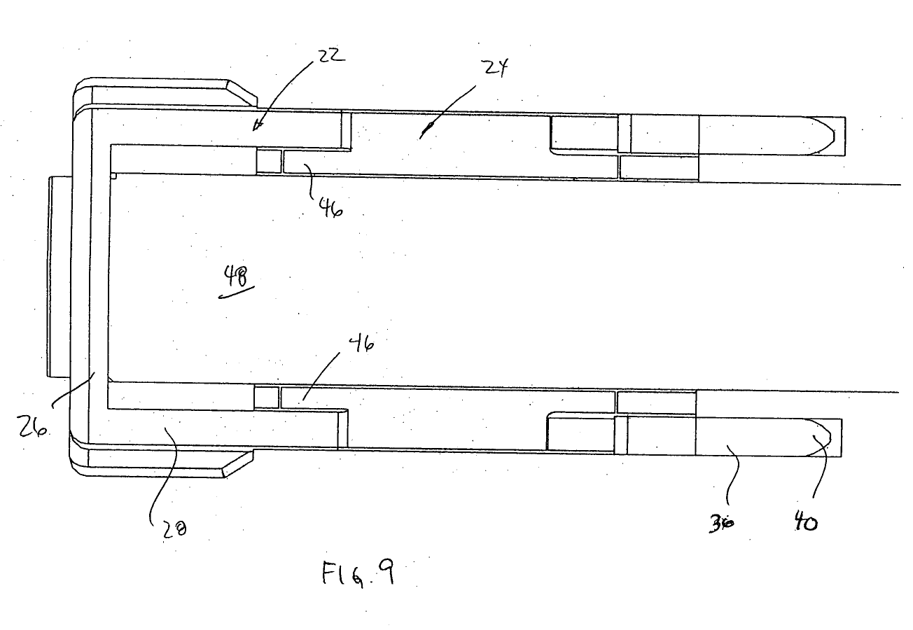

In the third and fourth positions, the inside surface of the guides 24 are spaced inwardly from the inside surface of the side portion 28 of U-shaped bracket 22 as shown in FIGS. 3, 6 and 9. A collar 46 is formed around saw hole 34 such that when in the third and fourth positions, the inside surface of guides 24 is spaced inwardly.

The door lock installation kit of the present invention is designed for use with doors having a thickness of 1⅜ inches or 1¾ inches and with a backset of 2⅜ inches or 2¾ inches. Accordingly there are four potential settings, namely a first position of 2⅜″×1¾″; a second position of 2¾″×1¾″; a third position of 2⅜″×1⅜″ and a fourth position of 2¾″×1⅜″. However, it will be appreciated by those skilled in the art that other sets of thicknesses and backsets may also be used. For the spacings described above the distance between the side portions 28 is 1¾ inches and the thickness of the collar 46 is 3/16 inch.

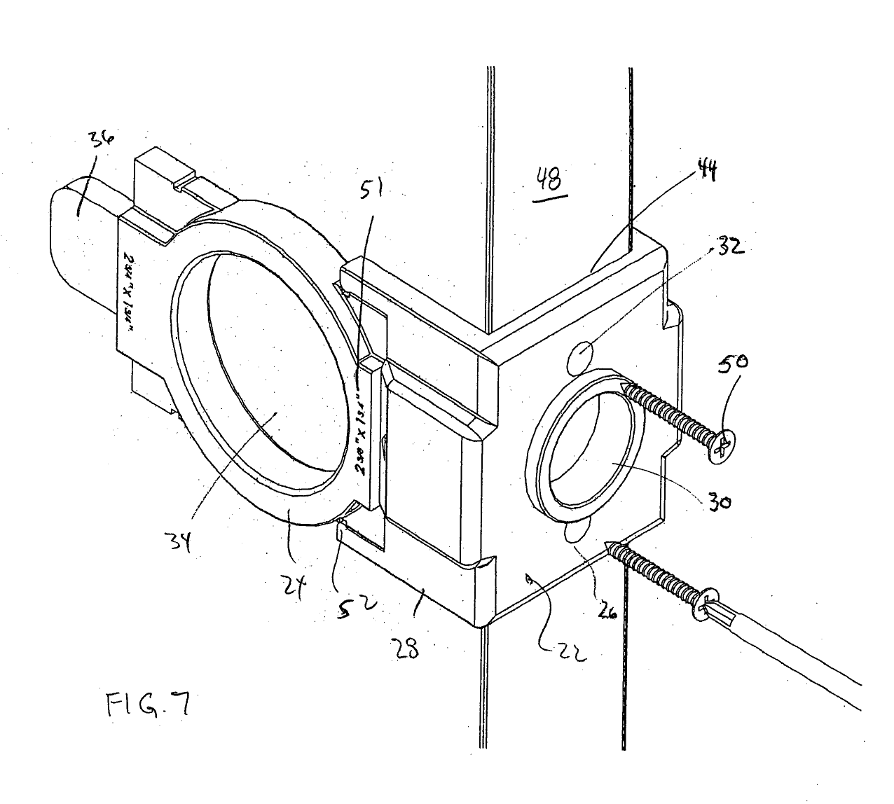

In use, the hole saw guides 24 snap into the U-shaped bracket 22 at each end of the side portion 28 of the bracket 22 so that the 2⅛″ saw holes 34 are perpendicular to the 1″ latch hole 30 of the bracket 22. The hole saw guides 24 are oriented according to the varying thicknesses (FIGS. 1 and 3) that doors 48 (shown in FIG. 7) are available in and backsets (FIGS. 1 and 5) that the standard locksets are available in. Preferably the hole saw guides 24 are provided with thickness and backset information 51 on the face thereof to aid in the correct orientation of the hole saw guide 24. Once the orientation of the hole saw guides 24 are determined and snapped onto the bracket 22, the template 20 is mounted to the edge of the door 48 where the location of the lockset will be. Since the template 20 has only two pre-determined sizes for thickness, and is made out of a solid plastic with limited flexibility, the user achieves greater stability when it is secured to the edge of the door 48. The screws 50 that are provided with the standard lockset kits are temporarily used to secure the template 20 to the edge of the door 48 (FIG. 7) for drilling the holes, and ensuring that the backset of the 2⅛″ holes are drilled and positioned accurately.

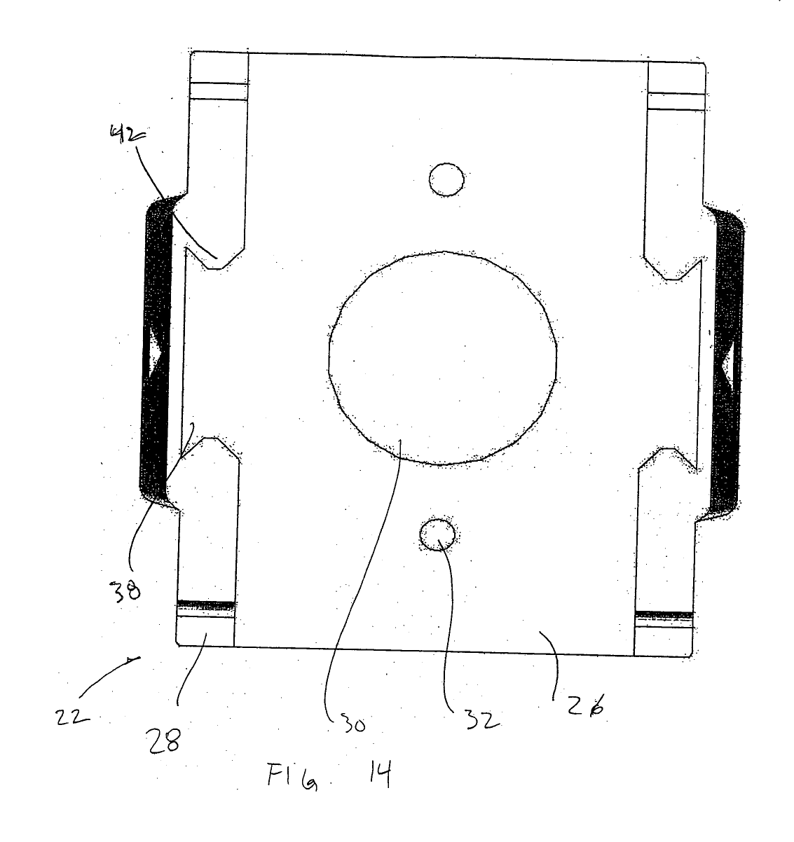

This door lock installation kit of the present invention can accommodate the two thicknesses of doors: 1⅜″ and 1¾″, as well as the two backsets of standard locksets: 2⅜″ and 2¾″. This is easily achieved by matching the indicated sizes of the 2⅛″ hole saw guides on each outside face of the U-shaped bracket shown in FIG. 5. The 2⅛″ hole saw guides are secure in the U-shaped bracket with a dovetail shape channel 38 (FIG. 14) and held in with snaps 52. The 2⅛″ hole saw guides can easily be snapped out of the U-shaped bracket to accommodate the other thickness and backsets of doors by either flipping or rotating the 2⅛″ hole saw guides and matching the indicated sizes to the U-shaped bracket.

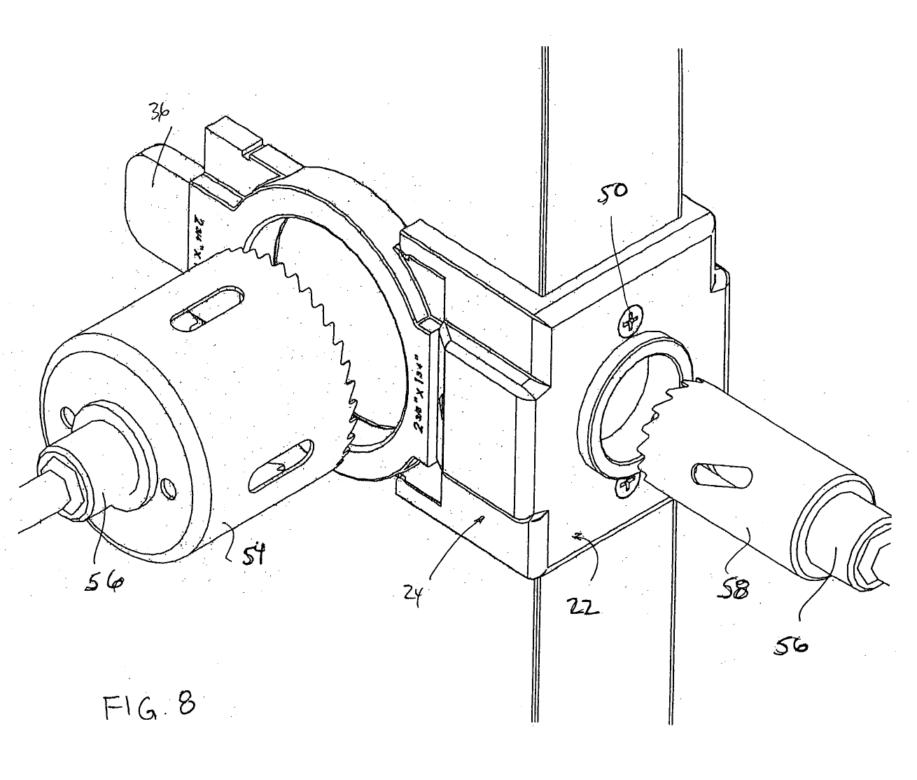

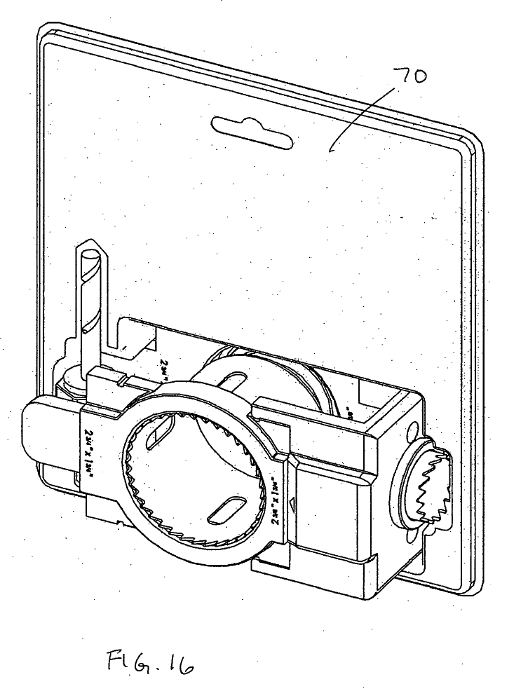

Once the template 20 is configured in its desired orientation, and mounted onto the edge of the door 48, FIG. 8 displays the method of drilling the holes. Since the template is U-shaped, the intention for the 2⅛″ hole is to drill through half the door from one side and finish drilling through on the other side to avoid the splintering on one side. Specifically, a 2⅛″ hole saw 54 is attached to mandrel 56 and affix to drill (not shown). The pilot drill should extend ¼″ past the teeth of the hole saw 54. The hole saw 54 is lined up with the saw hole 34 in the template 20 and drilling is begun. To eliminate splintering the user should stop drilling when the pilot drill breaks through the back of the door 48. The hole saw 54 is removed from one side of the door 48 and the hole is completed from the other side of the door 48. Again, the hole saw 54 is lined up with the saw hole 34 in template 20 using the pilot drill hole previously made and continue drilling until the hole is complete. The 2⅛″ hole saw 54 is removed from the mandrel 56 and replaced with the 1″ hole saw 58. Similarly, the pilot drill extends ¼″ past the teeth of the 1″ hole saw 58. The 1″ hole saw 58 is lined up with the latch hole 30 in the template 20 on the edge of the door 48. The latch hole is drilled through to the large face hole. Thereafter the latch plate screws 50 and the template 20 are removed from the door and the lockset is attached to the door 48 as provided in the instructions therewith. Preferably, as shown in FIG. 16, the door lock installation kit of the present invention is sold including the template 20, a mandrel 56, a hole saw 54 and a latch hole saw 58.

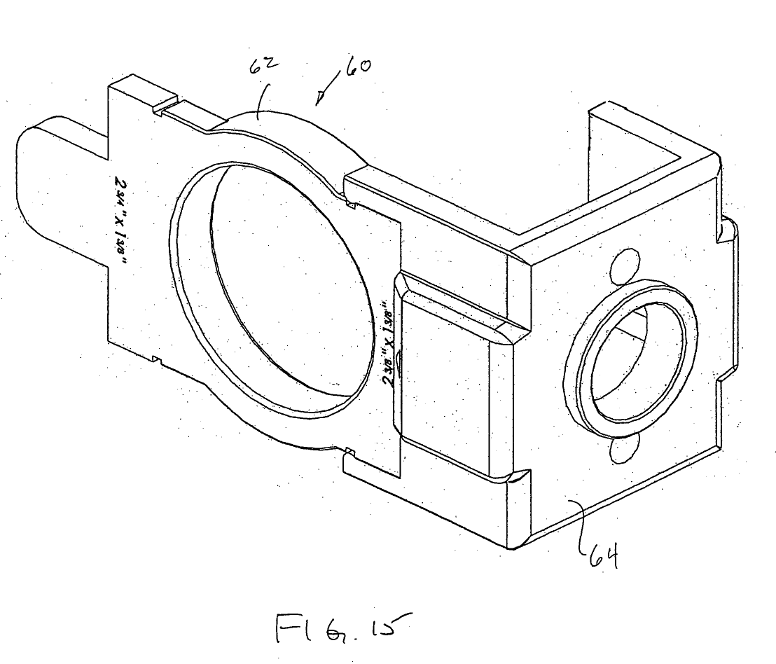

The door lock installation kit of the present invention is described above with a first and second hole saw guide 24. However, it will be appreciated by those skilled in the art that the kit could also work with only one hole saw guide 60. An example of this embodiment is shown in FIG. 15. This embodiment is similar to that described above however, the collar 62 would have a thickness of ⅜ inch and only one side of the U-shaped bracket 64 would receive a hole saw guide 60. The remainder of the kit would be essentially the same.

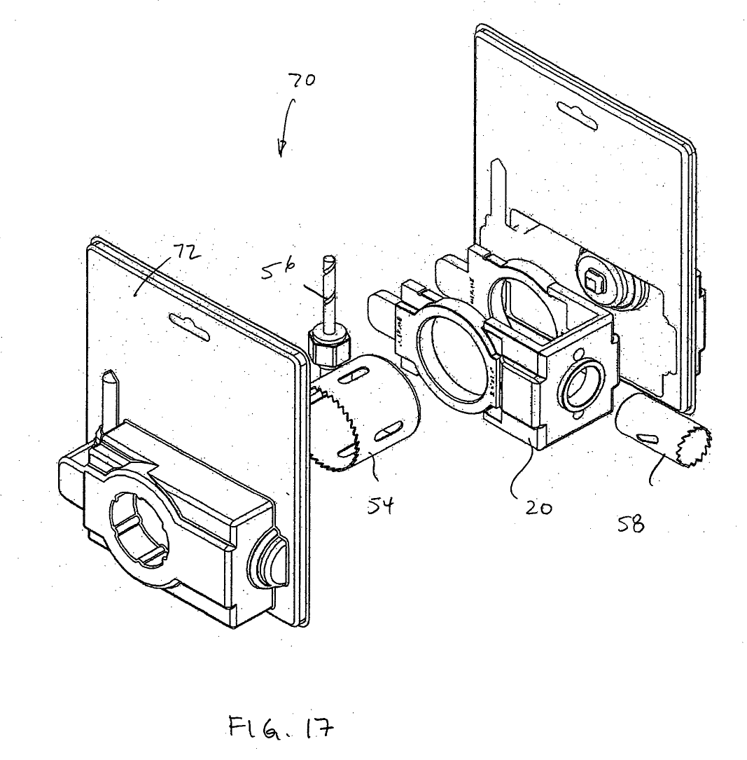

Referring to FIGS. 16 and 17, typically the door lock installation kit of the present invention would be sold as shown at 70. The kit 70 includes a template 20 as well as a mandrel 56, a hole saw 54 and a latch hole saw 58. There would all be packaged together in a sealed package 72.

As used herein, the terms “comprises” and “comprising” are to construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

What is claimed as the invention is:

1. A door lock installation kit for use as an aide to cutting holes in a door wherein a required backset from the edge of the door for the hole is chosen from at least two predetermined backsets, the kit comprising:
a U-shaped bracket having a front portion and a first and second side portion perpendicular thereto;
at least one hole saw guide removably attachable to one of the first and second side portions, each hole saw guide having a saw hole a predetermined distance from each end thereof, each hole saw guide being attachable in at least a first and a second position such that in the first position the backset is a first backset and in the second position the backset is a second backset.

2. A door lock installation kit as claimed in claim 1 wherein the at least one hole saw guide is a first hole saw guide and further including a second hole saw guide and when in position the saw holes in the first and second hole saw guides are aligned.

3. A door lock installation kit as claimed in claim 2 wherein the front portion of the U-shaped bracket further includes a latch hole formed therein.

4. A door lock installation kit as claimed in claim 3 wherein when the first and second hole saw guides are attached the saw holes and the latch hole each have a centre point that is at the same height.

5. A door lock installation kit as claimed in claim 3 wherein the first and second side portions of the U-shaped bracket have an inside surface and the hole saw guides each have a surface, the hole saw guides are further attachable in a third and fourth position, wherein in the first and second positions the surface of the first and second hole saw guides adjacent to the inside surface of the side portions of the U-shaped bracket is in the same plane and in the third and fourth positions at least a portion of the surface is spaced inwardly from the inside surface of the side portions of the U-shaped bracket, and wherein in the third position a backset is the first backset and in the fourth position a backset is a second backset.

6. A door lock installation kit as claimed in claim 5 wherein the front portion of the U-shaped bracket further includes an upper and a lower screw hole positioned above and below the latch hole for receiving a pair of screws used to releasably attach the bracket to a door.

7. A door lock installation kit as claimed in claim 6 wherein a distance between the side portions of the U-shaped bracket corresponds to a door having a thickness of 1¾ inches and a distance between the first and second hole saw guides when in the third and fourth positions corresponds to a door having a thickness of 1⅜ inches.

8. A door lock installation kit as claimed in claim 7 wherein the first backset is 2⅜ inches and the second backset is 2¾ inches.

9. A door lock installation kit as claimed in claim 5 wherein the first and second hole saw guides each have a collar around the saw hole that extends inwardly when the first and second hole saw guides are in one of the third and fourth positions.

10. A door lock installation kit as claimed in claim 3 wherein the side portion of the U-shaped bracket has a receiving portion and each hole saw guide has a finger extending outwardly from each end thereof and is configured such that the finger is receivable in the receiving portion in an inward orientation wherein one side faces inwardly and an outward orientation wherein the other side faces inwardly.

11. A door lock installation kit as claimed in claim 8 wherein each hole saw has a diameter adapted to receive a 2⅛ inch hole saw and the latch hole has a diameter adapted to receive a 1 inch hole saw.

12. A door lock installation kit as claimed in claim 8 further including a mandrel adapted to be attached to a drill and a first hole saw having a diameter that corresponds to the diameter of the saw hole in each hole saw guide and a second hole saw having a diameter that corresponds to the latch hole and each hole saw is attachable to the mandrel.

13. A door lock installation kit for use as an aide to cutting holes in a door wherein the door is one of two predetermined thicknesses, the kit comprising:
a U-shaped bracket having a front portion and a first and second side portion perpendicular thereto, the side portions each having an inside surface;
at least one hole saw guide removably attachable to the first and second side portions, each hole saw guide having a surface, each hole saw guide being attachable in a first and second door thickness position, wherein in the first door thickness position the surface of each hole saw guide adjacent to the inside surface of the side portions of the U-shaped bracket is in the same plane and in the second door thickness position at least a portion of the surface of each hole saw guide is spaced inwardly from the inside surface of the side portions of the U-shaped bracket.

14. A door lock installation kit as claimed in claim 13 wherein the at least one hole saw guide is a first hole saw guide and further including a second hole saw guide and wherein the first and second hole saw guides are arrangable such that when in position the saw holes in the first and second hole saw guides are aligned.

15. A door lock installation kit as claimed in claim 14 wherein the front portion of the U-shaped bracket further includes a latch hole formed therein.

16. A door lock installation kit as claimed in claim 15 wherein the front portion of the U-shaped bracket further includes an upper and a lower screw hole positioned above and below the latch hole for receiving a pair of screws used to releasably attach the bracket to a door.

17. A door lock installation kit as claimed in claim 16 wherein a distance between the side portions of the U-shaped bracket corresponds to a door having a thickness of 1¾ inches and a distance between the first and second hole saw guides when in the second door thickness position corresponds to a door having a thickness of 1⅜ inches.

18. A door lock installation kit as claimed in claim 17 wherein the first and second hole saw guides each have a collar around the saw hole that extends inwardly when the first and second hole saw guides are in the second door thickness position.

19. A door lock installation kit as claimed in claim 17 wherein the side portion of the U-shaped bracket has a receiving portion and each hole saw guide has a finger extending outwardly from each end thereof and is configured such that the finger is receivable in the receiving portion in an inward orientation wherein one side faces inwardly and an outwardly orientation wherein the other side faces inwardly.

20. A door lock installation kit as claimed in claim 17 wherein each hole saw has a diameter adapted to receive a 2⅛ inch hole saw and the latch hole has a diameter adapted to receive a 1 inch hole saw.

21. A door lock installation kit as claimed in claim 13 wherein a distance between the side portions of the U-shaped bracket corresponds to a door having a thickness of 1¾ inches and a distance between a side portion of the U-shaped bracket and the at least one hole saw guide when in the second door thickness position corresponds to a door having a thickness of 1⅜ inches.

22. A door lock installation kit as claimed in claim 15 further including a mandrel adapted to be attached to a drill and a first hole saw having a diameter that corresponds to the diameter of the saw hole in each hole saw guide and a second hole saw having a diameter that corresponds to the latch hole and each hole saw is attachable to the mandrel.

23. A door lock installation kit as claimed in claim 3 further including a mandrel adapted to be attached to a drill and a first hole saw having a diameter that corresponds to the diameter of the saw hole in each hole saw guide and a second hole saw having a diameter that corresponds to the latch hole and each hole saw is attachable to the mandrel.
